(19) United States
(12) Patent Application Publication
(10) Pub. No.: US 2023/0282884 A1
(43) Pub. Date: Sep. 7, 2023

(54) Electrolyte Solution for Lithium Secondary Battery and Lithium Secondary Battery Including the Same

(71) Applicants: SK Innovation Co., Ltd., Seoul (KR); SK ON CO., LTD., Seoul (KR)

(72) Inventors: Jin Hong Lee, Daejeon (KR); Hong Won Lee, Daejeon (KR); Chanwoo Kim, Daejeon (KR); Min Woo Park, Daejeon (KR); Min Young Lee, Daejeon (KR)

(21) Appl. No.: 18/116,687

(22) Filed: Mar. 2, 2023

(30) Foreign Application Priority Data
Mar. 3, 2022 (KR) 10-2022-0027584

(51) Int. Cl. H01M 10/0567; H01M 10/0525; H01M 10/0569; H01M 10/0568

(52) U.S. Cl. CPC H01M 10/0567; H01M 10/0525; H01M 10/0569; H01M 10/0568; H01M 2300/0028; H01M 2300/0051

(57) ABSTRACT

An electrolyte for a lithium secondary battery includes an organic solvent in an amount ranging from 90 wt % to 96% based on a total weight of the electrolyte solution, a lithium salt in an amount ranging from 0.01 wt % to 5 wt % based on the total weight of the electrolyte solution, and a triphenyl phosphate-based additive in an amount ranging from 3 wt % to 7 wt % based on the total weight of the electrolyte solution.

### CROSS-REFERENCE TO RELATED APPLICATION

This application claims priority to Korean Patent Application No. 10-2022-0027584 filed Mar. 3, 2022, the disclosure of which is hereby incorporated by reference in its entirety.

### BACKGROUND OF THE INVENTION

### 1. Field of the Invention

The present invention relates to an electrolyte solution for a lithium secondary battery and a lithium secondary battery including the same. More particularly, the present invention relates to an electrolyte solution for a lithium secondary battery including an organic solvent and an electrolytic salt, and a lithium secondary battery including the same.

### 2. Description of the Related Art

A secondary battery which can be charged and discharged repeatedly has been widely employed as a power source of a mobile electronic device such as a camcorder, a mobile phone, a laptop computer. Recently, a battery pack including the secondary battery is being developed and applied as an eco-friendly power source of an electric automobile, a hybrid vehicle, etc.

The secondary battery includes, e.g., a lithium secondary battery, a nickel-cadmium battery, a nickel-hydrogen battery, etc. The lithium secondary battery is widely used due to high operational voltage and energy density per unit weight, a high charging rate, a compact dimension, etc.

For example, the lithium secondary battery may include an electrode assembly including a cathode, an anode and a separation layer (separator), and an electrolyte solution immersing the electrode assembly. The lithium secondary battery may further include an outer case having, e.g., a pouch shape for accommodating the electrode assembly and the electrolyte solution.

As an application range of lithium secondary batteries is being expanded, extended life-span, higher capacity and operational stability are required. Accordingly, a lithium secondary battery capable of providing uniform power and capacity even during repeated charging and discharging is preferable.

However, power and capacity may be decreased due to surface damages of a nickel-based lithium metal oxide used as a cathode active material, and a side reactions between the nickel-based lithium metal oxide and an electrolyte may occur. Further, stability of the battery may be deteriorated in a harsh environment at high or low temperature.

For example, Korean Published Patent Application No. 10-2021-0001837 discloses a method for improving battery properties by adding an additive to a non-aqueous electrolyte for a lithium secondary battery.

### SUMMARY OF THE INVENTION

According to an aspect of the present invention, there is provided an electrolyte solution for a lithium secondary battery providing improved thermal and chemical stability.

According to an aspect of the present invention, there is provided a lithium secondary battery including the electrolyte solution and having improved thermal and chemical stability.

An electrolyte solution for a lithium secondary battery includes an organic solvent in an amount ranging from 90 wt % to 96% based on a total weight of the electrolyte solution, a lithium salt in an amount ranging from 0.01 wt % to 5 wt % based on the total weight of the electrolyte solution, and a triphenyl phosphate-based additive in an amount ranging from 3 wt % to 7 wt % based on the total weight of the electrolyte solution.

In some embodiments, the triphenyl phosphate-based additive may include a compound represented by Chemical Formula 1.

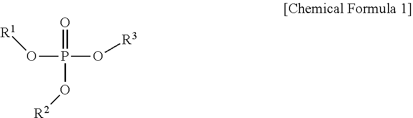

In Chemical Formula 1, R¹, R² and R³ may each be independently an aryl group. In some embodiments, the triphenyl phosphate-based additive may include a compound represented by Chemical Formula 1-1 or a compound represented by Chemical Formula 1-2.

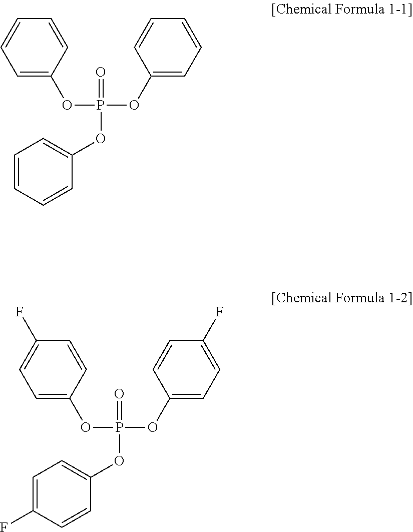 [SMILES: O=P(Oc1ccccc1)(Oc1ccccc1)Oc1ccccc1 ; O=P(Oc1ccc(F)cc1)(Oc1ccc(F)cc1)Oc1ccc(F)cc1]

In some embodiments, the triphenyl phosphate-based additive may include a compound represented by Chemical Formula 1-1 and a compound represented by Chemical Formula 1-2.

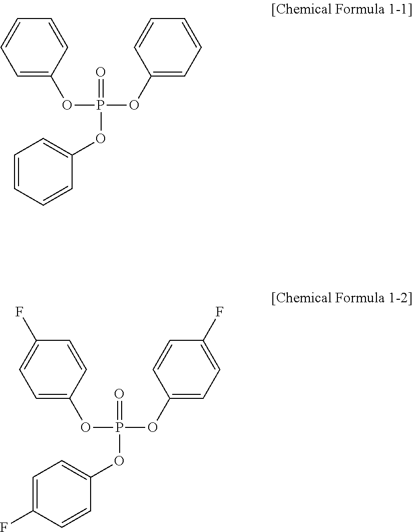 [SMILES: O=P(Oc1ccccc1)(Oc1ccccc1)Oc1ccccc1 ; O=P(Oc1ccc(F)cc1)(Oc1ccc(F)cc1)Oc1ccc(F)cc1]

In some embodiments, a weight ratio of the compound represented by Chemical Formula 1-2 to the compound represented by Chemical Formula 1-1 may be in a range from 1/9 to 9.

In some embodiments, the electrolyte solution may further include at least one borate-based lithium salt selected from the group consisting of lithium tetrafluoro borate, lithium bis(oxalate)borate, lithium difluoro(oxalato)borate and lithium bis(2-methyl-2-fluoro-malonato)borate.

In some embodiments, the borate-based lithium salt may include lithium bis(oxalate)borate.

In some embodiments, the borate-based lithium salt may be included in an amount ranging from 0.01 wt % to 5 wt % based on the total weight of the electrolyte solution.

In some embodiments, the electrolyte solution may further include at least one auxiliary additive selected from the group consisting of a cyclic carbonate-based compound, a fluorine-substituted cyclic carbonate-based compound, a sultone-based compound, a cyclic sulfate-based compound and an oxalatophosphate-based compound.

In some embodiments, the auxiliary additive may be included in an amount ranging from 0.01 wt % to 5 wt % based on the total weight of the electrolyte solution.

In some embodiments, the organic solvent may include at least one selected from the group consisting of ethylene carbonate (EC), ethyl methyl carbonate (EMC), dimethyl carbonate (DMC) and diethyl carbonate (DEC).

A lithium secondary battery includes an electrode assembly in which a plurality of cathodes and anodes are repeatedly stacked, a case accommodating the electrode assembly, and the electrolyte solution for a lithium secondary battery according the above-described embodiments accommodated together with the electrode assembly in the case.

An electrolyte solution for a lithium secondary battery according to embodiments of the present invention includes a triphenyl phosphate-based additive with a specific content to improve a flame retardancy and a cell performance.

For example, a calorific value of the electrolyte solution may be reduced to enhance the flame retardant properties. For example, initial properties and high-temperature storage properties of the secondary battery may be improved by the electrolyte solution to enhance the cell performance.

### BRIEF DESCRIPTION OF THE DRAWINGS

FIGS. 1 and 2 are a schematic plan view and a schematic cross-sectional view, respectively, illustrating a lithium secondary battery in accordance with exemplary embodiments.

### DESCRIPTION OF THE INVENTION

According to embodiments of the present invention, an electrolyte solution for a lithium secondary battery including a triphenyl phosphate-based additive with a specific content is provided. Further, a lithium secondary battery including the electrolyte solution and having improved flame retardancy and cell performance is also provided.

<Electrolyte for Lithium Secondary Battery>

An electrolyte solution for a lithium secondary battery according to exemplary embodiments of the present invention (hereinafter, that may be abbreviated as an electrolyte solution) may include an organic solvent, an electrolyte (e.g., a lithium salt), and a triphenyl phosphate-based additive.

In an embodiment, the organic solvent may be used in a residual amount or a remainder excluding the electrolyte, the additive, an auxiliary additive, etc. Preferably, the organic solvent may be included in an amount ranging from 90 weight percent (wt %) to 96 wt % based on a total weight of the electrolyte solution.

The term “residual amount” or “remainder” refers to a variable amount that may be adjusted depending on additional ingredients.

The organic solvent may include an organic compound that may provide sufficient solubility for the lithium salt, the triphenyl phosphate-based additive and the auxiliary additive and may not have reactivity with the lithium secondary battery. In some embodiments, a non-aqueous organic solvent may be used, and the electrolyte solution may be provided as a non-aqueous electrolyte solution.

In an embodiment, the organic solvent may include a carbonate-based solvent, an ester-based solvent, an ether-based solvent, a ketone-based solvent, an alcohol-based solvent, an aprotic solvent, etc. These may be used alone or in a combination thereof.

Examples of the carbonate-based solvent include dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC), butylene carbonate. etc.

Examples of the ester-based solvent include methyl acetate (MA), ethyl acetate (EA), n-propyl acetate (n-PA), 1,1-dimethylethyl acetate (DMEA), methyl propionate (MP), ethyl propionate (EP), γ-butyrolacton (GBL), decanolide, valerolactone, mevalonolactone, caprolactone, etc.

Examples of the ether-based organic solvent include dibutyl ether, tetraethylene glycol dimethyl ether (TEGDME), diethylene glycol dimethyl ether (DEGDME), dimethoxy ethane, 2-methyltetrahydrofuran, tetrahydrofuran, etc.

Examples of the ketone-based solvent include cyclohexanone. Examples of the alcohol-based solvent include ethyl alcohol, isopropyl alcohol, etc.

The aprotic solvent may include a nitrile-based solvent, an amide-based solvent such as dimethyl formamide (DMF), a dioxolane-based solvent such as 1,3-dioxolane, a sulfolane-based solvent, etc.

In a preferable embodiment, the carbonate-based solvent may be used as the organic solvent. For example, the organic solvent may include ethylene carbonate (EC), ethyl methyl carbonate (EMC), dimethyl carbonate (DMC), diethyl carbonate (DEC), or a combination thereof.

In an embodiment, a combination of at least two of ethylene carbonate (EC), ethyl methyl carbonate (EMC), dimethyl carbonate (DMC) and diethyl carbonate (DEC) may be used as the organic solvent.

In an embodiment, the electrolyte may include, e.g., a lithium salt. In a preferable embodiment, the lithium salt may be included in an amount ranging from 0.01 wt % to 5 wt %, preferably from 0.1 wt % to 2 wt %, based on the total weight of the electrolyte solution.

Within the above range, transfer of lithium ions and/or electrons may be promoted during charging and discharging of the lithium secondary battery, so that improved capacity may be achieved.

The lithium salt may be expressed as Li⁺X⁻, and non-limiting examples of the anion (X⁻) of the lithium salt include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc. These may be used alone or in a combination thereof.

According to embodiments of the present invention, the electrolyte may include the triphenyl phosphate-based additive. In a preferable embodiment, the triphenyl phosphate-based additive may be included in an amount ranging from 3 wt % to 7 wt %, preferably from 3.5 wt % to 6 wt %, based on the total weight of the electrolyte solution. More preferably, the triphenyl phosphate-based additive may be included in an amount ranging from 4 wt % or more and less than 5.5 wt %. Within the above content range, flame retardant properties and cell performance may be effectively improved.

For example, if the content of the triphenyl phosphate-based additive is less than 3 wt %, a high-temperature stability such as capacity retention and resistance properties may be improved, but the flame retardant property may be relatively deteriorated. If the content of the triphenyl phosphate-based additive exceeds 7 wt %, the flame retardant properties may be improved, but the high-temperature stability may be relatively deteriorated.

In an embodiment, the triphenyl phosphate-based additive may include a compound represented by Chemical Formula 1 below.

For example, the compound of Chemical Formula 1 may be added to stably protect a surface of an anode or a cathode. Accordingly, an electrode interface may be stabilized to suppress a side reaction with the electrolyte and improve battery performance such as battery capacity and life-span properties.

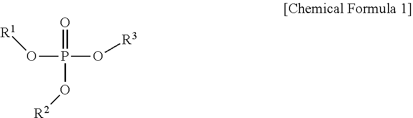

In Chemical Formula 1, R¹, R² and R³ may each independently be an aryl group.

As used herein, the term “aryl group” may refer to an aromatic ring containing group. Non-limiting examples of the aryl group include a phenyl group, a naphthyl group, a tetrahydronaphthyl group, etc. One or more hydrogen atom in the aryl group may be substituted with a substituent. The substituent may include such as an alkyl group, a halogen group, a nitrogen-containing group such as a nitro group and a cyano group, an oxygen-containing group such as an alkoxy group, a carbonyl group and an ester group, etc.

In some embodiments, R¹, R² and R³ may be the same aryl group. In some embodiments, at least two groups of R¹, R² and R³ may be different aryl groups.

In a preferable embodiment, the triphenyl phosphate-based additive may include a compound represented by Chemical Formula 1-1 or a compound represented by Chemical Formula 1-2 below.

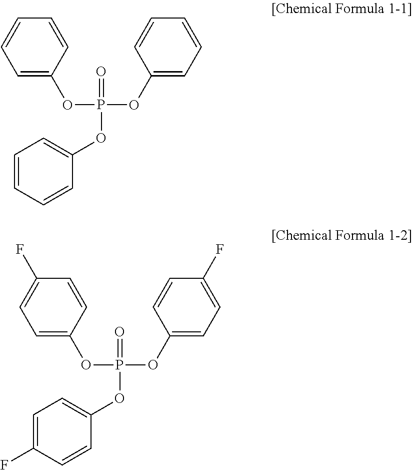 [SMILES: O=P(Oc1ccccc1)(Oc1ccccc1)Oc1ccccc1 ; O=P(Oc1ccc(F)cc1)(Oc1ccc(F)cc1)Oc1ccc(F)cc1]

Both the compound represented by Chemical Formula 1-1 and the compound represented by Chemical Formula 1-2 may have the flame retardant properties. The compound represented by Formula 1-2 contains a fluoro-group, and thus may have relatively improved flame retardant properties.

However, if the content of the flame retardant becomes 5 wt % or more of the total weight of the electrolyte solution, the extent of deterioration in cell performance by the compound represented by Chemical Formula 1-1 and the compound represented by Chemical Formula 1-2 may be similar.

Chemical Formula 1-1 represents triphenyl phosphate, and Chemical Formula 1-2 represents tris(4-fluorophenyl)phosphate

In an embodiment, the electrolyte solution may include the compound represented by Chemical Formula 1-1 alone or may include the compound represented by Chemical Formula 1-2 alone.

In an embodiment, the electrolyte solution may include both the compound represented by Chemical Formula 1-1 and the compound represented by Chemical Formula 1-2.

In an embodiment, a weight ratio of the compound represented by Chemical Formula 1-2 relative to the compound represented by Chemical Formula 1-1 may be in a range from 1/9 to 9. Preferably, the weight ratio may be in a range from 3/7 to 7/3, more preferably 5/5. Within the above range of the mixing ratio, the flame retardant properties and cell performance (e.g., initial cell performance and high-temperature storability) may be more effectively improved.

In an embodiment, the electrolyte solution may include a borate-based lithium salt. For example, the electrolyte solution may include lithium tetrafluoro borate, lithium bis(oxalate)borate, lithium difluoro(oxalato)borate, lithium bis(2-methyl-2-fluoro-malonato)borate, etc. Preferably, the electrolyte solution may further include lithium bis(oxalate)borate. Cell properties may be further improved by additionally including the borate-based lithium salt.

For example, bis(oxalate)borate may form a stable interface with the anode to suppress decomposition of the triphenyl phosphate-based additive, thereby improving the cell performance. Therefore, initial capacity and initial irreversible capacity may be increased, the initial resistance may be reduced, and the high-temperature properties may be improved.

In an embodiment, the borate-based lithium salt may be included in an amount ranging from 0.2 wt % to 2 wt % based on the total weight of the electrolyte solution. Within the above range, the above-described high-temperature cell properties may be more effectively improved.

In an embodiment, the electrolyte solution may further include the auxiliary additive. The auxiliary additive may be included in an amount ranging from 0.01 wt % to 5 wt %, preferably from 0.1 wt % to 4 wt % based on the total weight of the electrolyte solution.

For example, the auxiliary additive may include a cyclic carbonate-based compound, a fluorine-substituted cyclic carbonate-based compound, a sultone-based compound, a cyclic sulfate-based compound, an oxalatophosphate-based compound, etc.

The cyclic carbonate-based compound may include vinyl ethylene carbonate (VEC). In some embodiments, vinylene carbonate (VC) may be included as the cyclic carbonate-based compound including a double bond.

The fluorine-substituted cyclic carbonate-based compound may include fluoroethylene carbonate (FEC).

The sultone-based compound may include 1,3-propane sultone, 1,3-propene sultone, 1,4-butane sultone, etc.

The cyclic sulfate-based compound may include 1,2-ethylene sulfate, 1,2-propylene sulfate, etc.

The oxalatophosphate-based compound may include lithium difluoro bis(oxalato)phosphate, etc.

In a preferable embodiment, the fluorine-substituted cyclic carbonate-based compound, the sultone-based compounds, the cyclic sulfate-based compounds and the oxalatophosphate-based compound may be used together as the auxiliary additive.

The auxiliary additive may be added so that durability and stability of the electrode may be further improved. The auxiliary additive may be included in an appropriate amount within a range that may not inhibit mobility of lithium ions in the electrolyte.

<Lithium Secondary Battery>

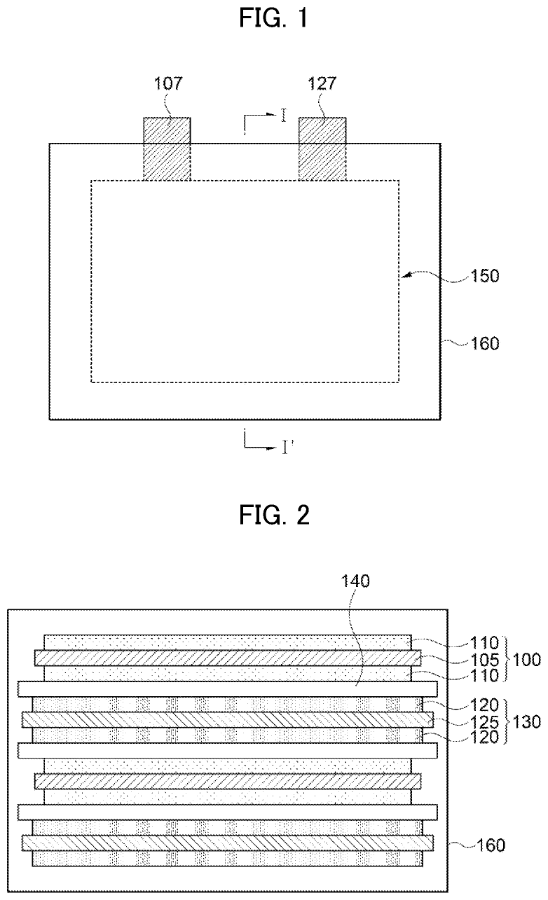

FIGS. 1 and 2 are a schematic top planar view and a schematic cross-sectional view, respectively, illustrating a lithium secondary battery in accordance with exemplary embodiments. Specifically, FIG. 2 is a cross-sectional view taken along a line I-I′ of FIG. 1.

Referring to FIGS. 1 and 2, a lithium secondary battery may include a cathode 100, an anode 130 facing the anode 100 and a separation layer 140 interposed between the cathode and the anode.

The electrode assembly may be accommodated in a case 160 together with the above-described electrolyte solution to be impregnated with the electrolyte.

The cathode 100 may include a cathode current collector 105 and a cathode active material layer 110 formed on the cathode current collector 105. The cathode active material may include a compound capable of reversibly intercalating and de-intercalating lithium ions.

In exemplary embodiments, the cathode active material may include a lithium-transition metal oxide. For example, the lithium-transition metal oxide includes nickel (Ni) and may further include at least one of cobalt (Co) and manganese (Mn).

For example, the lithium-transition metal oxide may be represented by Chemical Formula 1 below.

Li₁₊ₐNi_{1-(x+y)}COₓM_{y}O₂ [Chemical Formula 1]

In Chemical Formula 1, −0.05≤a≤0.2, 0.01≤x≤0.3, 0.01≤y≤0.3, and M may include at least one element selected from Mn, Mg, Sr, Ba, B, Al, Si, Ti, Zr and W.

As shown in Chemical Formula 1, the lithium-transition metal compound may include Ni in the highest content or molar ratio among Ni, Co and M. Ni may substantially act as a metal related to power and/or capacity of the lithium secondary battery. Ni may be included in the largest amount among transition metals, so that the high-capacity and high-power lithium secondary battery may be implemented.

In an embodiment, in Chemical Formula 1, 0.01≤x≤0.2 and 0.01≤y≤0.2. In an embodiment, the molar ratio of Ni may be 0.7 or more, or 0.8 or more.

When the content of Ni in the cathode active material or the lithium-transition metal oxide is increased, chemical stability and high-temperature storage stability of the secondary battery may be relatively degraded. Additionally, sufficient high power/high capacity properties from the high-Ni content may not be implemented due to surface damages of the cathode active material or a side reaction with the electrolyte during repeated charge/discharge cycles,

However, as described above, the triphenyl phosphate-based additive may be combined to Ni on the surface of the cathode active material or lithium-transition metal oxide through a coordination bond or a chemical interaction to provide passivation of the cathode active material. Therefore, the high power/high capacity properties through the high-Ni content may be substantially uniformly maintained for a long period even in a high temperature environment.

A slurry may be prepared by mixing and stirring the cathode active material with a binder, a conductive material and/or a dispersive agent in a solvent. The slurry may be coated on the cathode current collector 105, and then dried and pressed to form the cathode 100.

The cathode current collector 105 may include, e.g., stainless steel, nickel, aluminum, titanium, copper or an alloy thereof, and may preferably include aluminum or an aluminum alloy.

For example, the cathode binder may include an organic based binder such as polyvinylidenefluoride (PVDF), a polyvinylidene fluoride-hexafluoropropylene copolymer (PVDF-co-HFP), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 formed by coating an anode active material on a surface of the anode current collector 125.

The anode active material may include a material commonly used in the related art which may be capable of adsorbing and ejecting lithium ions. For example, a carbon-based material such as a crystalline carbon, an amorphous carbon, a carbon complex or a carbon fiber, a lithium alloy, a silicon-based compound, tin, etc., may be used.

The amorphous carbon may include a hard carbon, coke, a mesocarbon microbead (MCMB), a mesophase pitch-based carbon fiber (MPCF), etc. The crystalline carbon may include a graphite-based material such as natural graphite, graphitized coke, graphitized MCMB, graphitized MPCF, etc.

The lithium alloy may further include aluminum, zinc, bismuth, cadmium, antimony, silicon, lead, tin, gallium, indium, etc.

The silicon-based compound may include, e.g., silicon, a silicon oxide (SiOx; 0<x<2), or a silicon-carbon composite compound such as silicon carbide (SiC).

For example, a slurry may be prepared by mixing and stirring the anode active material with the above-described binder, conductive material, thickener, etc. The slurry may be coated on at least one surface of the anode current collector 125, and then dried and pressed to form the anode 130.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation.

An electrode cell may be defined by the cathode 100, the anode 130 and the separation layer 140. For example, a plurality of the electrode cells may be stacked to form an electrode assembly 150 in the form of, e.g., a jelly-roll. For example, the electrode assembly 150 may be formed by winding, laminating or folding the separation layer 140.

The electrode assembly 150 may be accommodated in the case 160 together with the electrolyte solution according to the exemplary embodiments as described above to define the lithium secondary battery.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be fabricated into a cylindrical shape using a can, a prismatic shape, a pouch shape, a coin shape, etc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

Synthesis of Triphenyl Phosphate-Based Additive

### (1) Synthesis Example 1

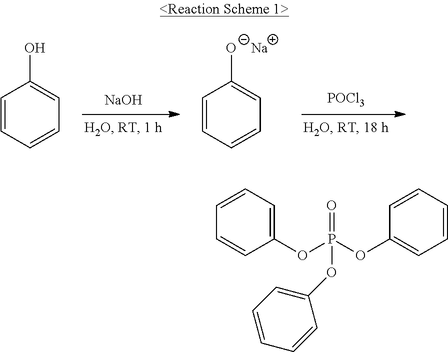

As shown in Reaction Scheme 1 above, triphenyl phosphate was synthesized in two steps as an additive represented by Chemical Formula 1-1.

Specifically, after quantifying 200 ml of water in a 500 ml rounded bottom flask, 20 g (213 mmol) of phenol and 9.4 g (234 mmol) of NaOH were quantified and mixed. After vigorous stirring for 1 hour while maintaining 0° C. in a nitrogen environment, 10.5 g (68 mmol) of phosphorous oxychloride (POCl₃) was slowly dropped into a reactor. The mixture was further stirred for 18 hours at room temperature while maintaining a nitrogen environment. After completion of the reaction, triphenyl phosphate was extracted with an organic solvent layer by mixing 200 ml of dichloromethane.

After mixing and extracting 100 ml of 5% NaOH aqueous solution and 100 ml of water each once in the obtained organic solvent layer, solvent and moisture were removed by vacuum drying.

### (2) Synthesis Example 2

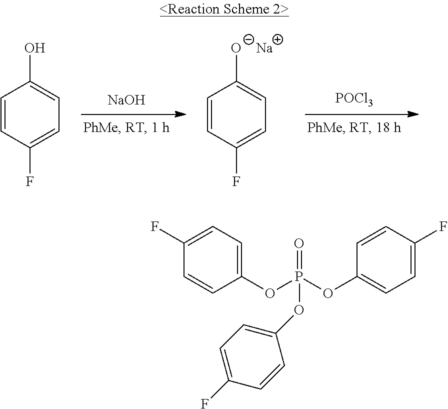

As shown in Reaction Scheme 2 above, tris(4-fluorophenyl)phosphate as an additive represented by Chemical Formula 1-2 was synthesized in two steps.

Specifically, after quantifying 300 ml of toluene in a 500 ml rounded bottom flask, 50 g (446 mmol) of 4-fluorophenol and 19.6 g (491 mmol) of NaOH were quantified and mixed. After vigorous stirring for 1.5 hours while maintaining 0° C. in a nitrogen environment, 20.7 g (135 mmol) of phosphorous oxychloride (POCl₃) was slowly dropped into a reactor. The mixture was further stirred for 21 hours at room temperature while maintaining a nitrogen environment.

After completion of the reaction, residual starting materials were quenched by mixing with 200 ml of 10% NaOH, and tris(4-fluorophenyl)phosphate was extracted with an organic solvent layer. After mixing and extracting 200 ml of water 3 times in the obtained organic solvent layer, the organic solvent layer was vacuum dried to remove solvent and moisture.

### EXAMPLES AND COMPARATIVE EXAMPLES

### Example 1

(1) Preparation of Electrolyte Solution

A 1.0M LiPF₆ solution (using EC/EMC mixed solvent in a 25:75 volume ratio) was prepared. 1 wt % of fluoroethylene carbonate (FEC), 0.5 wt % of 1,3-propanesultone (PS), 0.5 wt % of 1,3-propenesultone (PRS), 0.5 wt % of ethylene sulfate (ESA) and lithium difluoro bis(oxalato)phosphate (W3) were input, and 3 wt % of triphenyl phosphate synthesized in Synthesis Example 1 was added as the triphenyl phosphate-based additive based on a total weight of the electrolyte solution (ESA).

(2) Preparation of Lithium Secondary Battery Sample

A cathode active material in which Li[Ni_{0.6}Co_{0.2}Mn_{0.2}]O₂ and Li[Ni_{0.8}Co_{0.1}Mn_{0.1}]O₂ were mixed in a weight ratio of 6:4, carbon black as a conductive material, and polyvinylidene fluoride as a binder (PVdF) was mixed in a weight ratio of 92:5:3 to prepare a slurry. The slurry was uniformly coated on an aluminum foil having a thickness of 15 m, vacuum dried and pressed at 130° C. to prepare a cathode for a lithium secondary battery.

95 wt % of an anode active material including artificial graphite and natural graphite in a weight ratio of 7:3, 1 wt % Super-P as a conductive material, 2 wt % styrene-butadiene rubber (SBR) as a binder, and 2 wt % of carboxymethyl cellulose (CMC) as a thickener were mixed to form an anode slurry. The anode slurry was uniformly coated on a copper foil having a thickness of 15 m, and dried and pressed to form an anode.

The cathodes and the anodes prepared as described above were cut into predetermined sizes and stacked with a separator (polyethylene, thickness of 20 m) interposed therebetween to from an electrode assembly. Tab portions of the cathodes and the anodes were welded.

The electrode assembly was placed in a pouch and sealed at three sides except for an electrolyte injection side. The tab portions were included in the sealed portion. The electrolyte solution prepared in the above (1) was injected through the electrolyte injection side, the electrolyte injection side was also sealed, and then impregnation was performed for 12 hours or more to obtain a lithium secondary battery sample.

### Example 2

A secondary battery sample was prepared by the same method as that in Example 1, except that 5 wt % of triphenyl phosphate was added when preparing the electrolyte solution.

### Example 3

A secondary battery sample was prepared by the same method as that in Example 1, except that 7 wt % of triphenyl phosphate was added when preparing the electrolyte solution.

### Example 4

A secondary battery sample was prepared by the same method as that in Example 1, except that 3 wt % of tris(4-fluorophenyl)phosphate was added instead of triphenyl phosphate when preparing the electrolyte solution.

### Example 5

A secondary battery sample was prepared by the same method as that in Example 1, except that 5 wt % of tris(4-fluorophenyl)phosphate was added instead of triphenyl phosphate when preparing the electrolyte solution.

### Example 6

A secondary battery sample was prepared by the same method as that in Example 1, except that 7 wt % of tris(4-fluorophenyl)phosphate was added instead of triphenyl phosphate when preparing the electrolyte solution.

### Example 7

A secondary battery sample was prepared by the same method as that in Example 1, except that 3 wt % of a mixture of triphenyl phosphate and tris(4-fluorophenyl)phosphate was added instead of triphenyl phosphate when preparing the electrolyte solution. A weight ratio of tris(4-fluorophenyl)phosphate to triphenyl phosphate in the mixture was adjusted to 5/5.

### Example 8

A secondary battery sample was prepared by the same method as that in Example 7, except that 5 wt % of the mixture of triphenyl phosphate and tris (4-fluorophenyl) phosphate was added when preparing the electrolyte solution.

### Example 9

A secondary battery sample was prepared by the same method as that in Example 7, except that 7 wt % of the mixture of triphenyl phosphate and tris (4-fluorophenyl) phosphate was added when preparing the electrolyte solution.

### Example 10

A secondary battery sample was prepared by the same method as that in Example 2, except that 1 wt % of LiBOB was added as a borate-based lithium salt when preparing the electrolyte solution.

### Example 11

A secondary battery sample was prepared by the same method as that in Example 5, except that 1 wt % of LiBOB was added as a borate-based lithium salt when preparing the electrolyte solution.

### Example 12

A secondary battery sample was prepared by the same method as that in Example 8, except that 1 wt % of LiBOB was added as a borate-based lithium salt when preparing the electrolyte solution.

### Comparative Example 1

A secondary battery sample was prepared by the same method as that in Example 1, except that triphenyl phosphate was not added when preparing the electrolyte solution.

### Comparative Example 2

A secondary battery sample was prepared by the same method as that in Example 1, except that 2 wt % of triphenyl phosphate was added when preparing the electrolyte solution.

### Comparative Example 3

A secondary battery sample was prepared by the same method as that in Example 1, except that 8 wt % of triphenyl phosphate was added when preparing the electrolyte solution.

### Comparative Example 4

A secondary battery sample was prepared by the same method as that in Example 1, except that 2 wt % of tris(4-fluorophenyl)phosphate was added instead of triphenyl phosphate when preparing the electrolyte solution.

### Comparative Example 5

A secondary battery sample was prepared by the same method as that in Example 1, except that 8 wt % of tris(4-fluorophenyl)phosphate was added instead of triphenyl phosphate when preparing the electrolyte solution.

### Comparative Example 6

A secondary battery sample was prepared by the same method as that in Example 1, except that 2 wt % of a mixture of triphenyl phosphate and tris(4-fluorophenyl)phosphate was added instead of triphenyl phosphate when preparing the electrolyte solution.

### Comparative Example 7

A secondary battery sample was prepared by the same method as that in Example 1, except that 8 wt % of a mixture of triphenyl phosphate and tris(4-fluorophenyl)phosphate was added instead of triphenyl phosphate when preparing the electrolyte solution.

### Experimental Example

(1) Differential Scanning Calorimetry (DSC) Evaluation

The electrolytes of the secondary batteries of Examples and Comparative Examples were analyzed by a differential scanning calorimetry (DSC) to evaluate thermal properties. METTLER TOLEDO was used as an analytical instrument.

(2) Heat Exposure Measurement (Hot Box Test)

The secondary batteries of Examples and Comparative Examples were placed in an oven, heated at 5° C./min (30-minute test during ramping) to 150° C., and then a time (delay time) until the cell exploded when maintained for 3 hours was measured.

(3) Evaluation of Initial Properties

3-1) Initial Capacity Evaluation

CC/CV charge (4.2V, 0.05 C cut-off) at 0.5 C-rate and 0.5 C-rate CC discharge (2.7V cut-off) at 25° C. for each secondary battery of Examples and Comparative Examples were performed. Thereafter, a discharge capacity was measured. The measurement was conducted three times.

3-2) Internal Resistance (DCIR) Evaluation

At an SOC 60% point, a C-rate was increased by 0.2 C, 0.5 C, 1.0 C, 1.5 C, 2.0 C, 2.5 C, or 3.0 C, and an end point of a voltage when charging and discharging of the corresponding C-rate proceeded for 10 seconds was calculated using an equation of a straight line. A slope of the equation was adopted as a DCIR.

(4) Evaluation on High Temperature Storage Properties

4-1) Evaluation of Capacity Retention (Ret) after High Temperature Storage

The secondary batteries of Examples and Comparative Examples stored at 60° C. for 8 weeks in a state of SOC 100% were discharged at 0.5 C-rate CC (2.7V cut-off), and then a discharge capacity was measured.

A capacity retention was calculated as a percentage of the discharge capacity after the high temperature storage relative to the initial capacity measured in the above 3-1.

Capacity retention (%)=(discharge capacity after storage at high temperature/initial capacity)×100

4-2) Evaluation of Internal Resistance (DCIR) after High Temperature Storage

An internal resistances of the secondary batteries of Examples and Comparative Examples stored at 60° C. for 8 weeks in a state of SOC 100% were measured by the same method as that in the above 3-2, and then an increasing ratio of the DCIR was calculated.

The evaluation results are shown in Tables 1 to 4 below.

TABLE 1

| | | Example | Example | Example | Comparative | Comparative | Comparative |
|---|---|---|---|---|---|---|---|
| No. | | 1 | 2 | 3 | Example 1 | Example 2 | Example 3 |
| DSC | calorific | 250 | 242 | 239 | 288 | 281 | 229 |
| | value | | | | | | |
| | (J/g) | | | | | | |
| Hot box test | | 2.9 min | 3.2 min | 3.3 min | 137° C. event | 0.1 min | 4.1 min |
| (delay time) | | | | | | | |
| initial | capacity | 1690 | 1682 | 1671 | 1714 | 1701 | 1580 |
| properties | (Ah) | | | | | | |
| | DCIR | 47 | 49 | 49 | 42 | 45 | 68 |
| | (mΩ) | | | | | | |
| high | capacity | 95 | 95 | 94 | 97 | 96 | 84 |
| temperature | retention | | | | | | |
| storage | (%) | | | | | | |
| for | DCIR | 13 | 14 | 16 | 8 | 11 | 27 |
| 8 weeks | increasing | | | | | | |
| | ratio (%) | | | | | | |

TABLE 2

| | | Example | Example | Example | Comparative | Comparative | Comparative |
|---|---|---|---|---|---|---|---|
| No. | | 4 | 5 | 6 | Example 1 | Example 4 | Example 5 |
| DSC | calorific | 238 | 231 | 229 | 288 | 284 | 221 |
| | value | | | | | | |
| | (J/g) | | | | | | |
| Hot box test | | 6.5 min | 7.2 min | 7.3 min | 137° C. event | 0.3 min | 12 min |
| (delay time) | | | | | | | |
| initial | capacity | 1710 | 1701 | 1680 | 1714 | 1701 | 1545 |
| properties | (Ah) | | | | | | |
| | DCIR | 45 | 46 | 47 | 42 | 47 | 69 |
| | (mΩ) | | | | | | |
| high | capacity | 94 | 94 | 91 | 97 | 91 | 89 |
| temperature | retention | | | | | | |
| storage | (%) | | | | | | |
| for | DCIR | 15 | 14 | 13 | 8 | 18 | 29 |
| 8 weeks | increasing | | | | | | |
| | ratio (%) | | | | | | |

TABLE 3

| | | Example | Example | Example | Comparative | Comparative | Comparative |
|---|---|---|---|---|---|---|---|
| No. | | 7 | 8 | 9 | Example 1 | Example 6 | Example 7 |
| DSC | calorific | 231 | 228 | 227 | 288 | 279 | 222 |
| | value | | | | | | |
| | (J/g) | | | | | | |
| Hot box test | | 11 min | 12.5 min | 13.5 min | 137° C. event | 0.5 min | 13 min |
| (delay time) | | | | | | | |
| initial | capacity | 1668 | 1691 | 1714 | 1699 | 1714 | 1591 |
| properties | (Ah) | | | | | | |
| | DCIR | 48 | 46 | 42 | 40 | 49 | 70 |
| | (mΩ) | | | | | | |
| high | capacity | 95 | 93 | 96 | 94 | 90 | 81 |
| temperature | retention | | | | | | |
| storage | (%) | | | | | | |
| for | DCIR | 18 | 14 | 8 | 9 | 18 | 39 |
| 8 weeks | increasing | | | | | | |
| | ratio (%) | | | | | | |

TABLE 4

| | | No. | | |
|---|---|---|---|---|
| | | Example | Example | Example |
| | | 10 | 11 | 12 |
| DSC | calorific value (J/g) | 241 | 230 | 225 |
| Hot box test (delay time) | | 3.3 min | 12 min | 13.5 min |
| initial | capacity (Ah) | 1693 | 1780 | 1700 |
| properties | DCIR (mΩ) | 47 | 45 | 43 |
| high | capacity retention (%) | 97 | 98 | 99 |
| temperature | DCIR increasing | 10 | 12 | 13 |
| storage for 8 | ratio (%) | | | |
| weeks | | | | |

Referring to Table 1, in the secondary batteries of Examples 1 to 3 where the electrolyte solutions containing triphenyl phosphate were used as the triphenyl phosphate-based additive represented by Chemical Formula 1-1, improved flame retardant properties were achieved compared to those from the secondary battery of Comparative Example 1 containing no triphenyl phosphate. Specifically, low calorific values of the electrolyte solutions were measured through the DSC evaluation, and high thermal stability was confirmed through the thermal exposure evaluation.

Referring to Comparative Examples 2 and 3, as the triphenyl phosphate content became greater, the flame retardant properties were improved, but the cell performance (the initial properties and the high-temperature storage properties) was degraded. However, in Examples 1 to 3, both the flame retardant properties and the cell performance were improved.

Referring to Table 2, in the secondary batteries of Examples 4 to 6 where the electrolyte solutions containing tris(4-fluorophenyl)phosphate were used as the triphenyl phosphate-based additive represented by Chemical Formula 1-2, improved flame retardant properties were obtained compared to those from the secondary battery of Comparative Example 1 containing no tris(4-fluorophenyl)phosphate. Specifically, the triphenyl phosphate-based additive containing a fluorine group was used to further enhance the flame retardant properties from the DSC evaluation and thermal stability from the heat exposure evaluation.

Referring to Comparative Examples 4 and 5, as the content of the triphenyl phosphate-based additive containing the fluorine group became greater, the flame retardant properties were improved, but the cell performance (the initial properties and the high-temperature storage properties) was degraded. However, in Examples 4 to 6, both the flame retardant properties and the cell performance were improved.

Referring to Table 3, in the secondary batteries of Examples 7 to 9 where the electrolyte solutions containing the mixture of triphenyl phosphate and tris(4-fluorophenyl)phosphate was used, improved flame retardant properties were obtained compared to those from the secondary battery of Comparative Example 1 devoid of the mixture of triphenyl phosphate and tris(4-fluorophenyl)phosphate. Specifically, the mixture of triphenyl phosphate and tris(4-fluorophenyl)phosphate was used to further enhance the flame retardant properties from the DSC evaluation and thermal stability from the heat exposure evaluation.

Referring to Comparative Examples 6 and 7, as the content of the mixture of triphenyl phosphate and tris(4-fluorophenyl)phosphate became greater, the flame retardant property increases were improved, but the cell performance (the initial properties and the high-temperature storage properties) was degraded. However, in Examples 7 to 9, the mixture of triphenyl phosphate and tris(4-fluorophenyl)phosphate was included in the predetermined mixing ratio to improve both the flame retardant properties and the cell performance.

Referring to Table 4, the cell performance was further improved by adding lithium bis(oxalate)borate to the above-described triphenyl phosphate-based additive. Specifically, the capacity retention was increased at high temperature and the resistance increasing ratio was reduced while sufficiently obtaining the flame retardant properties. For example, it is predicted that added lithium bis(oxalate)borate formed a stable interface on the anode to suppress decomposition of the triphenyl phosphate-based additive, thereby improving the cell performance.

What is claimed is:

1. An electrolyte solution for a lithium secondary battery, comprising:
an organic solvent in an amount ranging from 90 wt % to 96% based on a total weight of the electrolyte solution;
a lithium salt in an amount ranging from 0.01 wt % to 5 wt % based on the total weight of the electrolyte solution; and
a triphenyl phosphate-based additive in an amount ranging from 3 wt % to 7 wt % based on the total weight of the electrolyte solution.

2. The electrolyte solution for a lithium secondary battery according to claim 1, wherein the triphenyl phosphate-based additive comprises a compound represented by Chemical Formula 1: 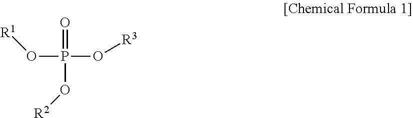
wherein, in Chemical Formula 1, R¹, R² and R³ are each independently an aryl group.

3. The electrolyte solution for a lithium secondary battery according to claim 2, wherein the triphenyl phosphate-based additive comprises a compound represented by Chemical Formula 1-1 or a compound represented by Chemical Formula 1-2:

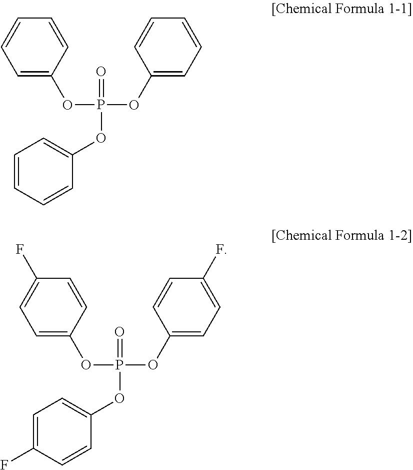 [SMILES: O=P(Oc1ccccc1)(Oc1ccccc1)Oc1ccccc1 ; O=P(Oc1ccc(F)cc1)(Oc1ccc(F)cc1)Oc1ccc(F)cc1]

4. The electrolyte solution for a lithium secondary battery of claim 2, wherein the triphenyl phosphate-based additive comprises a compound represented by Chemical Formula 1-1 and a compound represented by Chemical Formula 1-2:

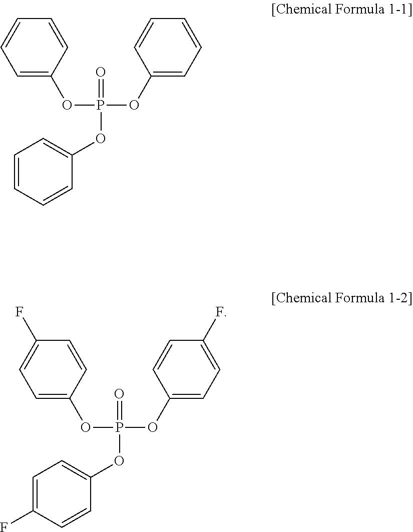 [SMILES: O=P(Oc1ccccc1)(Oc1ccccc1)Oc1ccccc1 ; O=P(Oc1ccc(F)cc1)(Oc1ccc(F)cc1)Oc1ccc(F)cc1]

5. The electrolyte solution for a lithium secondary battery according to claim 4, wherein a weight ratio of the compound represented by Chemical Formula 1-2 to the compound represented by Chemical Formula 1-1 is in a range from 1/9 to 9.

6. The electrolyte solution for a lithium secondary battery according to claim 1, wherein the electrolyte solution further comprises at least one borate-based lithium salt selected from the group consisting of lithium tetrafluoro borate, lithium bis(oxalate)borate, lithium difluoro(oxalato)borate and lithium bis(2-methyl-2-fluoro-malonato)borate.

7. The electrolyte solution for a lithium secondary battery according to claim 6, wherein the borate-based lithium salt includes lithium bis(oxalate)borate.

8. The electrolyte solution for a lithium secondary battery according to claim 6, wherein the borate-based lithium salt is included in an amount ranging from 0.01 wt % to 5 wt % based on the total weight of the electrolyte solution.

9. The electrolyte solution for a lithium secondary battery according to claim 1, wherein the electrolyte solution further comprises at least one auxiliary additive selected from the group consisting of a cyclic carbonate-based compound, a fluorine-substituted cyclic carbonate-based compound, a sultone-based compound, a cyclic sulfate-based compound and an oxalatophosphate-based compound.

10. The electrolyte solution for a lithium secondary battery according to claim 9, wherein the auxiliary additive is included in an amount ranging from 0.01 wt % to 5 wt % based on the total weight of the electrolyte solution.

11. The electrolyte for a lithium secondary battery according to claim 1, wherein the organic solvent includes at least one selected from the group consisting of ethylene carbonate (EC), ethyl methyl carbonate (EMC), dimethyl carbonate (DMC) and diethyl carbonate (DEC).

12. A lithium secondary battery, comprising:
an electrode assembly in which a plurality of cathodes and anodes are repeatedly stacked;
a case accommodating the electrode assembly; and
the electrolyte solution for a lithium secondary battery of claim 1 accommodated together with the electrode assembly in the case.
